(19) United States
(12) Patent Application Publication
(10) Pub. No.: US 2006/0154032 A1
(43) Pub. Date: Jul. 13, 2006

(54) Washcloth with water reactive motifs

(75) Inventors: Melanie Roy, Ste-Marie de Beauce (CA); Marise Drouin, Scott (CA); Richard Auger, St-Elzear (CA)

Correspondence Address: ROBIC, CENTRE CDP CAPITAL, 1001, VICTORIA SQUARE - BLOC E - 8TH FLOOR, MONTREAL, QC, H2Z 2B7, CA

(73) Assignee: TEXEL INC.

(21) Appl. No.: 11/324,306

(22) Filed: Jan. 4, 2006

(30) Foreign Application Priority Data
Jan. 13, 2005 (CA) 2,493,075

(51) Int. Cl. B32B 27/04; B32B 27/12; B32B 3/00; B32B 5/02

(52) U.S. Cl. 428/196; 442/121; 442/123; 442/118; 442/153; 442/164

(57) ABSTRACT

Disclosed is a washcloth having at least one motif printed thereon with an ink that reacts with water so as to let the motif either appear or disappear when the washcloth is wet. Also disclosed is a washcloth having at least one motif that is printed thereon with an indelible ink and is covered with a water soluble hiding material that disappears when the washcloth is wet and thus lets the motif appear. Such a washcloth is preferably disposable and can particularly be used for encouraging children to clean themselves.

### FIELD OF THE INVENTION

The present invention relates to a cleaning article. More specifically, it relates to a washcloth provided with water reactive motifs.

### BACKGROUND OF THE INVENTION

Washcloths, such as cleansing cloths, facecloths, wipes, flannels, tissues, washrags, towels, sponge-towels and the like, are well known for cleansing and scrubbing the skin in order to mechanically remove dirt. Washcloths are also known for laying and, if necessary, lathering soap, cleansing gel or cream over the skin.

Washcloths have traditionally been designed to be reused. Recently, disposable washcloths have been devised either to wash small areas of the body or to avoid having to clean them after use.

Washcloths are usually stored in sealing containers and made of non-woven fabrics or paper pulp. The existing washcloths are also generally impregnated with a cleansing, disinfectant and/or antiseptic substrate. Some washcloths have also been devised for skin treatments.

There are numerous patents directed to washcloths. By way of non restrictive examples, U.S. Pat. No. 6,960,349 (SHANTZ and al.) discloses a disposable wipe saturated with a baby cleansing lotion. U.S. Pat. No. 6,844,303 (LANGE) discloses a non irritant and non-sting cleansing composition and feminine hygiene wipes containing the composition. U.S. Pat. No. 6,613,729 (COLE), U.S. Pat. No. 6,589,922 (DOW et al.) and U.S. Pat. No. 6,440,437 (KRZYSIK) disclose methods for making disposable wipes saturated with aqueous substrates. In these patents, the wipes are designed for cleansing specific parts of the body.

Depending on the disinfectant wipes, the saturating substrates may be different. For example, U.S. Pat. Nos. 6,488,943, 6,482,423, 6,413,529, 6,258,368, and 6,183,763 (BEERSE et al.) and U.S. Pat. No. 5,753,246 (PETERS) disclose wipes with antimicrobial and antiviral agents. Wipes without any saturating substrate are also available for aesthetical purposes. U.S. Pat. No. 4,546,516 (KIM) discloses a cosmetic towel for removing moisture from the skin. U.S. Pat. No. 6,645,611 (SETH) discloses an oil absorbing wipe for wiping the skin or the hair. US laid open patent application 2003/0206940 (GOTT et al.) discloses a disposable substrate having active and non-active zones. The substrate disclosed in these applications comprises a system for indicating the fact that agents have been transferred from the substrate to the user's body.

Among products that are more specifically designed for encouraging children to clean themselves and take a bath, there exist washing gloves sized to fit a child's hand. The gloves are impregnated with soap for cleansing the child. The gloves are devised to be rinsed and reused. Decorations such as amusing characters are printed on top of the gloves. Such decorations are actually the main incentive that push the children to clean themselves.

The concept of using decorations that appear and/or disappear in contact with water, is already known as such. Such a concept has actually been used in children bath books which have decorations or motifs printed on their pages in such a manner as to appear or disappear depending on whether the corresponding page is wet or dry. By way of example, there exist books wherein, on some pages, drawings are made of soap which can dissolve in water. Books also exist which are printed with a special ink so that hidden pictures appear when the books are in a bath. However, such a concept has never been used with washcloths.

In the field of sanitary products, especially diapers, it has been already suggested to use diapers or similar products that give a visual indication when wet. By way of example, U.S. Pat. No. 5,163,846 (LEE) discloses a resin filled with silica, which is suitable for use in diapers. The resin disclosed in this patent becomes transparent when wet, and shows a background image. U.S. Pat. No. 3,702,610 (SHEPPARD et al.) discloses the use of an ink in combination with soluble adhesives as an indicator of wetness. U.S. Pat. No. 4,022,211 (TIMMONS et al.) also discloses the use of an ink as an indicator of wetness of a baby's diaper. Once again, it has however never been suggested to use the same concept in washcloths.

### SUMMARY OF THE INVENTION

A first object of the present invention is to provide a washcloth comprising at least one motif printed thereon with an ink that reacts with water so as to let the motif either appear or disappear when the washcloth is wet.

Another object of the invention is to provide a washcloth comprising at least one motif printed thereon with an indelible ink. This at least one motif is covered with a water soluble hiding material that disappears when the washcloth is wet and thus lets the at least one motif appear.

In both cases, the washcloth is preferably disposable and particularly devised for use to encourage children to clean themselves.

The present invention and its advantages will be better understood upon reading the following non-restrictive detailed description of it.

### DETAILED DESCRIPTION OF THE INVENTION

As aforesaid, the washcloth according to the present invention comprises at least one motif printed thereon.

In a first preferred embodiment of the invention, the motif is printed with a water soluble ink. When the washcloth is wet, the motif either appears or disappears. In a second preferred embodiment of the invention, the washcloth comprises at least one motif printed thereon with an indelible ink. Such a motif is covered with a water soluble hiding material that disappears when the washcloth is wet and thus lets the motif appear. The soluble water hiding initially forms a temporary mask covering the motif.

In another preferred embodiment of the invention, the washcloth may comprise both appearing and disappearing motifs.

Preferably, the ink comprises a soluble water binder, a coloring agent and optionally a cleaning agent. The binder may comprise agar or gelatine, or it may comprise polyvinyl alcohol or polyethylene glycol. The coloring agent may be a dye, a pigment or a combination thereof. The cleaning agent may be a soap or skin cleansing agent. Preferably, the cleaning agent is selected so as to make the motif(s) solid at ambient temperature. Thus, the cleaning agent may serve as the binder.

When the washcloth is intended to be used for body care, it is of course obvious that the components of the ink such as the cleaning agent, can be chosen among products useful for external body care.

Preferably, the washcloth is made of paper pulp or a woven or non woven material. The washcloth can be made of natural fibers, such as cellulose or cotton, or of synthetic fibers, such as polyester, polypropylene, viscose or an acrylic derivative, or a combination of natural and synthetic fibers. It will be understood that the invention is not limited to the above examples of natural and synthetic fibers.

In a preferred embodiment of the invention, the washcloth may have a rectangular form with a length and a width ranging from 5 to 50 cm. In another embodiment of the invention, the washcloth may be devised so as to have a partially closed shape, such as, for example, the shape of a glove.

The appearance and/or disappearance of motifs on the washcloth are particularly interesting, especially for encouraging children to take a bath. When the washcloth is designed for children, the at least one motif could be amusing characters or any other motifs which might traditionally amuse a child.

### EXAMPLE

A disposable washcloth for encouraging children to take a bath was prepared as follows.

A non woven material of 100 g/m² was prepared from polyester fibers of 2 deniers. On this non woven material, supposedly ugly characters were printed with soluble ink so that these ugly characters may disappear when the washcloth is wet. The soluble ink used for the printing comprised 74% of an aqueous dispersion, 14% of alcohol ethoxysulphate, 5% of Myrisil isopropylamide Coco MIPA, 5% of cocoamidopropyl betaine and 1% of a dispersion of green or yellow pigment. The aqueous dispersion also comprised 20% of polyvinyl alcohol. The green pigment was a green chrome hydroxide and the yellow pigment a yellow dye no. 5.

Each of these characters was 3 cm in height. The spacing between the characters was 6 cm. The characters were printed with at least two colors by using a rotary cylinder printer. After printing, the characters were dried at a temperature of 160° C. (320° F.) in a 40-meter-long oven at a 15 m/min speed.

The so prepared non woven material was then cut into rectangles of 20 cm×25 cm. The washcloths were then either sewn, soldered, glued, needled or moulded to form a partially closed shape such as a glove having a size and shape designed for fitting a child's hand.

Tests have been carried out with these gloves and have proved to be very positive.

Although in the above example a washcloth that was manufactured, was essentially designed for encouraging a child to take a bath, the same concept could be used to prepare washcloths for adults. As a matter of fact, the motifs can be of any type. For example, they could be figures or texts, in relation with topics that are more likely to suit selected users.

Of course, the above-described embodiments are only illustrative examples of what could be accomplished with the present invention. It should indeed be understood that numerous modifications could be made to the invention as disclosed hereinabove, without departing from the scope of the invention as apparent to a person skilled in the art.

1. A washcloth comprising at least one motif printed thereon with an ink that reacts with water so as to let the motif either appear or disappear when the washcloth is wet.

2. The washcloth of claim 1, wherein said washcloth is made of paper pulp or of a woven or non woven material.

3. The washcloth of claim 2, wherein said washcloth is made of natural fibers, synthetic fibers or a combination thereof.

4. The washcloth of claim 3, wherein said fibers consist of cellulose or cotton.

5. The washcloth of claim 3, wherein said fibers consist of polyester, polypropylene, viscose or an acrylic derivative.

6. The washcloth of claim 1, wherein said washcloth is of a rectangular form with a length and a width ranging from 5 to 50 cm.

7. The washcloth of claim 1, wherein said washcloth is devised so as to have a partially closed shape.

8. The washcloth of claim 7, wherein said washcloth is in the form of a glove.

9. The washcloth of claim 1, wherein said ink comprises a soluble water binder, a coloring agent and optionally a cleaning agent.

10. The washcloth of claim 9, wherein the binder comprises agar or gelatine.

11. The washcloth of claim 9, wherein the binder comprises, polyvinyl alcohol or polyethylene glycol.

12. The washcloth of claim 9, wherein the coloring agent is a dye, a pigment or a combination thereof.

13. The washcloth of claim 9, wherein the cleaning agent is a soap or skin cleansing agent.

14. The washcloth of claim 13, wherein the cleaning agent is selected so as to make the at least one motif solid at ambient temperature.

15. The washcloth of claim 3, wherein said ink comprises:
a water soluble binder;
a coloring agent which is a dye, a pigment or a combination thereof;
a cleaning agent which is a soap or skin cleansing agent.

16. The washcloth of claim 15, wherein said washcloth is in the form of a glove.

17. A washcloth comprising at least one motif printed thereon with an indelible ink, said at least one motif being covered with a water soluble hiding material that disappears when the washcloth is wet and thus let said at least one motif appear.
